(19) United States
(12) Patent Application Publication
(10) Pub. No.: US 2003/0212722 A1
(43) Pub. Date: Nov. 13, 2003

(54) Architecture for performing fast fourier-type transforms

(75) Inventors: Raj Kumar Jain, Mandarin Gardens (SG); Seo How Low, Santa Cruz, CA (US)

Correspondence Address: HORIZON IP PTE LTD, 166 KALLANG WAY, 6TH FLOOR, SINGAPORE, 349249, SG

(73) Assignee: Infineon Technologies Aktiengesellschaft.

(21) Appl. No.: 10/211,651

(22) Filed: Aug. 2, 2002

Related U.S. Application Data
(63) Continuation-in-part of application No. 10/140,904, filed on May 7, 2002.

(51) Int. Cl. G06F 15/00

(52) U.S. Cl. 708/404

(57) ABSTRACT

A processor for performing fast Fourier-type transform operations is disclosed. At least one multiplier and a plurality of adders are provided to perform butterfly operations comprising three multiply operations and a plurality of add operations. Internal wordlengths are wider than wordlengths of input values to reduce rounding error.

This is a continuation-in-part of patent application titled “Architecture for Performing Fast Fourier Transforms and Inverse Fast Fourier Transforms”, U.S. Ser. No. 10/140,904 (attorney docket number 12205/15).

### FIELD OF THE INVENTION

The present invention relates generally to integrated circuits (ICs). More particularly, the invention relates to architectures for performing fast Fourier-type transform operations.

### BACKGROUND OF THE INVENTION

The Discrete Fourier Transform (DFT) is applied extensively in many instrumentation, measurement and digital signal processing applications. The N-point DFT of a sequence x(k) in the time domain, where N=2^{m} and m is an integer, produces a sequence of data X(n) in the frequency domain. The transform equation is as follows:

$$X ( n ) = {\sum }_{k = 0}^{N - 1} x ( k ) {W}_{N}^{n}$$

where n=0, 1 . . . , N−1;

and the inverse DFT of X(n) can be defined as follows:

$$x ( k ) = \frac{1}{N} {\sum }_{n = 0}^{N - 1} X ( n ) {W}_{N}^{- n}$$

W represents the twiddle factor, where W_{N}=cos(2πk/N)−j sin(2πk/N), and k=0, 1 . . . , (N−1).

Several techniques have been proposed to speed up the DFT computation, one of which is the Fast Fourier transform (FFT) or inverse fast Fourier Transform (IFFT), which exploits the symmetry and periodicity properties of the DFT. The IFFT/FFT has found many real-time applications in, for example, data communications systems where it is used to modulate/demodulate discrete multitone (DMT) or orthogonal frequency division multiplexing (OFDM) waveforms.

FIG. 1 shows an implementation of an N-point inverse Fourier transform using a decimation-in-frequency (DIF) technique. Illustratively, a radix-2 DIF transform is implemented for an 8-point transform. The DIF technique divides the output frequency sequence into even and odd portions to split the DFTs into smaller core calculations. Other FFT techniques, such as decimation-in-time(DIT), are also useful. The FFT and IFFT computation comprises a series of complex multiplications, known as butterflies (106). Each butterfly computing unit comprises, for example, adders and multipliers.

FIG. 2 shows a block diagram of a basic FFT butterfly 201. The modified input values X and Y of each FFT butterfly are typically computed from the inputs A and B, according to the following equations:

$$\begin{matrix}X = A + B \\ = ( {A}_{r} + {B}_{r} ) + j ( {A}_{i} + {B}_{i} ) ; \\ Y = ( A - B ) * W \\ = ( {C}_{r} + {jC}_{i} ) * ( {W}_{r} + {jW}_{i} ) \\ = ( {C}_{r} * {W}_{r} - {C}_{i} * {W}_{i} ) + j ( {C}_{i} * {W}_{r} + {C}_{r} * {W}_{i} ) ;\end{matrix}$$

where

C=(Aᵣ−Bᵣ)+j(Aᵢ−Bᵢ); and

W=cos(2πk/N)−j sin(2πk/N).

The complex data variables, such as A, B and C, comprise real and imaginary parts, indicated by the subscript “r” and “i” respectively.

The complex multiplication for modified input value Y typically involves four multiply operations and two add operations. For an N-point sequence, there are typically N/2 butterflies per stage and log₂N stages. Hence, (4*N/2)log₂N=2Nlog₂N multiply and Nlog₂N add operations would be required to compute the FFT. Using one multiplier, the butterfly operation is completed in at least four cycles. If additional multipliers are provided to increase computational efficiency, the size of the chip is increased, which undesirably hinders miniaturization as well as increases the cost of manufacturing.

As evidenced from the above discussion, it is the object of the invention to provide a processor having an improved architecture for performing fast Fourier-type transform operations at higher speeds.

### SUMMARY OF THE INVENTION

The invention relates, in one embodiment, to a processor for performing fast Fourier-type transform operations. At least one multiplier and a plurality of adders are provided to perform butterfly operations, wherein the butterfly operation comprises three multiply operations and a plurality of add operations. In one embodiment, intermediate results have wordlengths that are wider than the wordlengths of input values to reduce rounding error. In one embodiment, saturation detection and rounding are performed on these intermediate results.

### BRIEF DESCRIPTION OF THE DRAWINGS

FIG. 1 shows an N-point inverse fast Fourier transform;

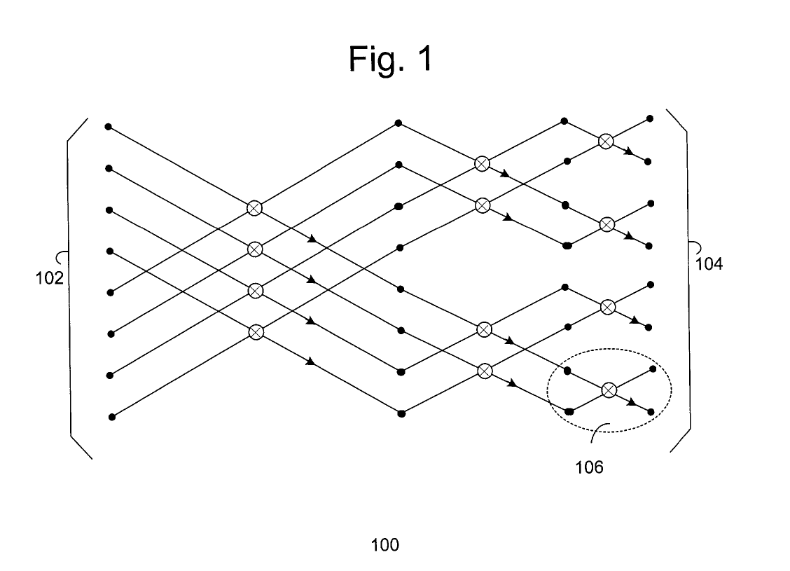

FIG. 2 shows a block diagram of a basic FFT butterfly;

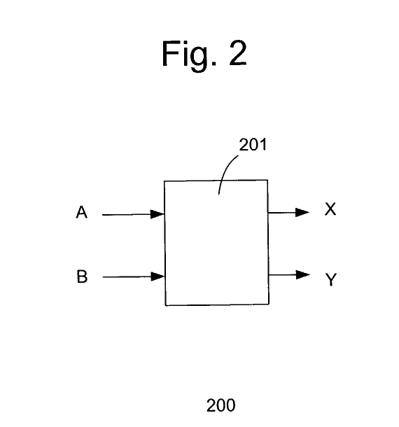

FIG. 3 shows a block diagram of one embodiment of the invention;

FIG. 4 shows the architecture of one embodiment of the invention; and

FIG. 5 shows a timing diagram according to one embodiment of the invention.

### PREFERRED EMBODIMENTS OF THE INVENTION

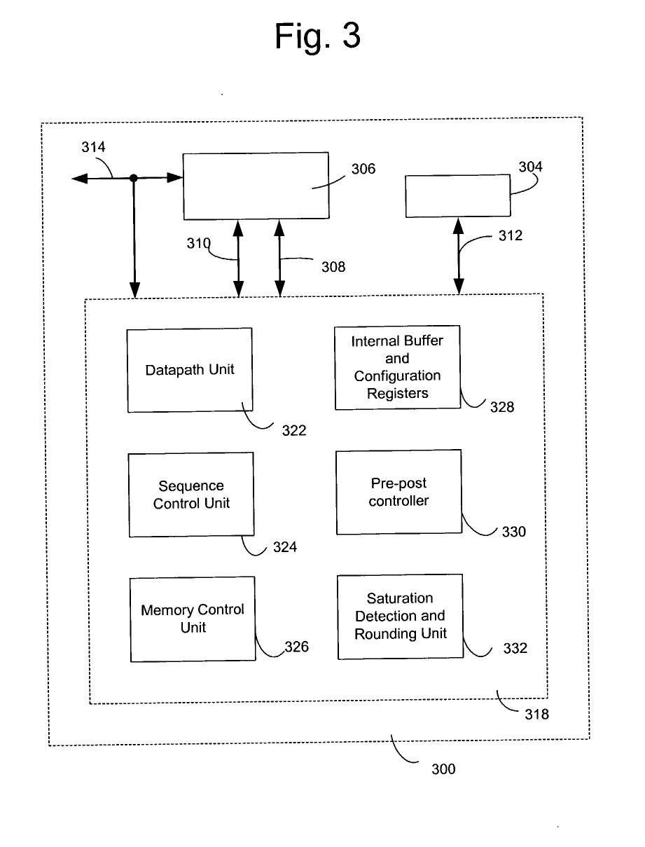

FIG. 3 shows the architecture of a processor 300 according to one embodiment of the present invention. The processor performs fast Fourier-type operations (e.g. FFT) to convert input data on a time domain to output data on a frequency domain. Alternatively, the processor performs fast Fourier-type operations (e.g. IFFT) to convert input data on a frequency domain to output data on a time domain.

In one embodiment of the invention, the processor 300 comprises a memory unit 304, preferably a read-only memory (ROM), for storing pre-computed constants (e.g. twiddle factors) and a memory unit 306 for storing input data and modified input values of the FFT or IFFT. In one embodiment, memory unit 304 is integrated with memory unit 306. Other types of memories and memory configurations are also useful. Input data is transferred to the memory unit 306 via bus 314. Other types of data, for example, configuration and control data, may also be transferred via bus 314. The memory unit is coupled to a computation unit 318 via, for example, buses 308 and 310. Other types of buses and bus configurations are also useful.

During the FFT computation, input values are transferred from the memory unit to the computation unit 318. The computation unit comprises, for example, a datapath unit 322. The datapath unit comprises, in one embodiment, includes the logic to compute FFT or IFFT butterfly operations on input values (A and B), generating modified input values (X and Y). In accordance to the invention, the terms of the FFT butterfly equations may be rearranged to reduce space and power consumption. In one embodiment, the real and imaginary components for modified input values (X and Y) are expanded and rearranged as follows:

$$\begin{matrix}X = A + B \\ = ( {A}_{r} + {B}_{r} ) + j ( {A}_{i} + {B}_{i} ) ;\end{matrix}$$

Yᵣ=(CᵣWᵣ−CᵢWᵢ)=Cᵣ*(Wᵣ+Wᵢ)−D;

Yᵢ=(CᵣWᵢ+CᵢWᵣ)=Cᵢ*(Wᵣ−Wᵢ)+D;

where

C=(Aᵣ−Bᵣ)+j(Aᵢ−Bᵢ);

W=cos(2πk/N)−j sin(2πk/N); and

D=Wᵢ*(Cᵣ+Cᵢ).

By identifying D as the common term, the number of multiply operations may be reduced to only three in the computation of the real and imaginary parts of Y. Hence, a reduction of about 25% in the number of multiply operations is achieved, thereby lowering power and chip space consumption without increasing hardware requirements. For an N-point sequence having N/2 butterflies per stage and log₂N stages, only (3N/2)log₂N multiply operations would be required to compute the FFT.

Similarly, for each IFFT butterfly having two inputs A and B and two modified inputs X and Y, the terms of the equations may be rearranged to identify the common term D, as follows:

X=(Aᵣ+Bᵣ)+j(Aᵢ+Bᵢ);

Yᵣ=Cᵣ*(Wᵣ−Wᵢ)+D;

Yᵢ=Cᵢ*(Wᵣ+Wᵢ)−D;

where

C=(Aᵣ−Bᵣ)+j(Aᵢ−Bᵢ);

W=cos(2πk/N)−j sin(2πk/N); and

D=Wᵢ*(Cᵣ+Cᵢ)

Hence, the number of multiply operations is reduced by about 25%, resulting in a significant reduction in chip space and power requirements.

In one embodiment, the datapath unit includes at least one multiplier and a plurality of adders. A sequence control unit 324 may be included to control the flow of data in the datapath unit. After the butterfly computation, the modified input values are fed back to the datapath unit a prescribed number of times until the FFT or IFFT computation is completed. The final results are written back to the memory unit 306. Memory access is controlled by, for example, the memory control unit 326. There is further included, in one embodiment, configuration registers 328 for storing configuration data and an internal buffer for storing intermediate results.

In one embodiment, the computation unit 318 includes a pre-processing and post-processing controller 330 coupled to the datapath processor 322 for further reducing the computational time complexity. The use of a pre/post-processing controller is described in copending patent application titled “Architecture for Performing Fast Fourier Transforms and Inverse Fast Fourier Transforms”, U.S. Ser. No. 10/140,904 (attorney docket number 12205/15), which is herein incorporated by reference for all purposes.

During the computation of FFT or IFFT, modified input values (X and Y) at each stage are rounded off and stored in the internal buffer 328. These values are subsequently retrieved and used to compute butterfly computations in the next stage. Intermediate results typically comprise fixed wordlengths, resulting in rounding errors accumulating over the iterative stages, hence reducing the accuracy of the final FFT or IFFT results.

In order to reduce the round-off error at the final output, wider internal wordlengths are provided. For example, the input values may be stored in memory as 16-bit words. The wordlength of intermediate results may be increased to, for example, 18-bits for higher accuracy. The computation unit 318 further includes a saturation detection and rounding unit 332 in one embodiment. The intermediate results are preferably rounded off when saturation is detected.

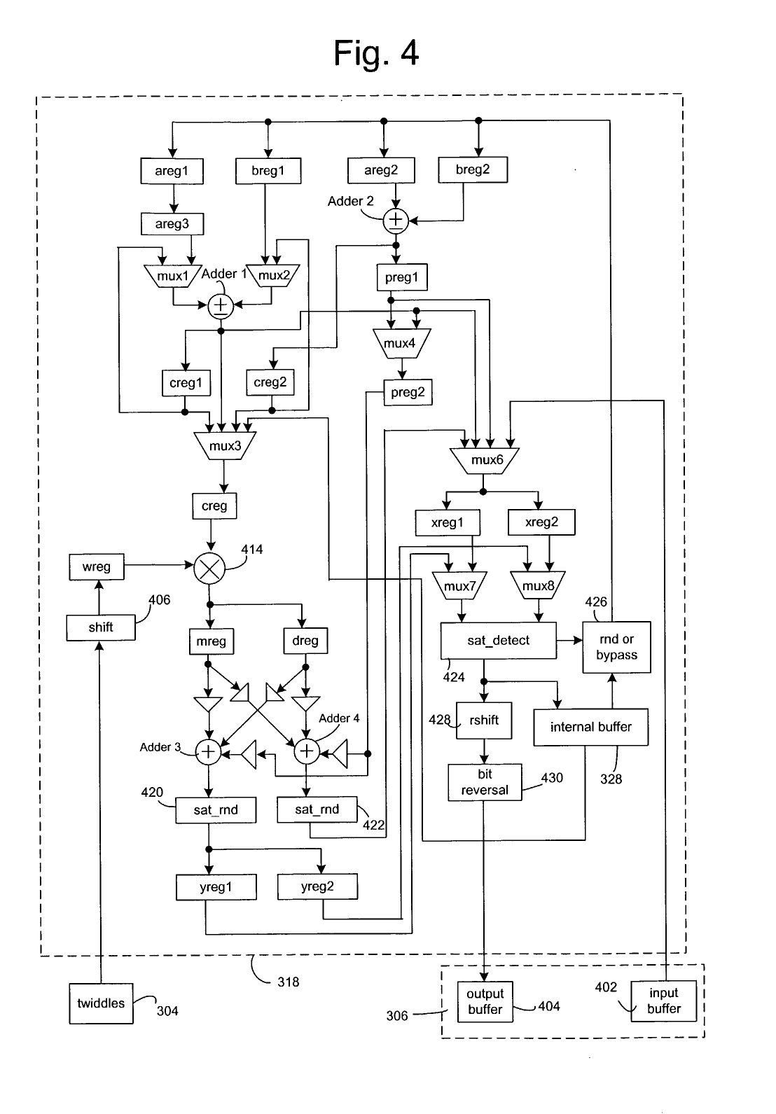

FIG. 4 shows the architecture of the computation unit of a FFT processor according to one embodiment of the invention. The processor computes the FFT results using three-multiply-cycle butterflies, according to the aforementioned equations. In one embodiment, support for pre-processing and post-processing is included in the architecture.

The computation unit 318 is coupled to a memory unit 306 comprising input buffer 402 and output buffer 404. Other types of memory configurations are also useful. In one embodiment, the computation unit is also coupled to a memory unit 304 which stores pre-computed twiddle values such as the imaginary components Wᵢ of the twiddle factors, as well as pre-computed sums (Wᵣ+Wᵢ) and differences (Wᵣ−Wᵢ) of the twiddle factors. In one embodiment, the twiddle values occupy consecutive word locations in the memory. In one embodiment, the pre-computed sum and difference may be scaled down by, for example, a factor of 2, to occupy the same wordlength as the single terms (e.g. Wᵢ). When the sum and difference values are retrieved from the ROM, compensation may be made by scaling the values using the shift unit 406.

In one embodiment, the computation unit comprises an internal buffer 328 for storing intermediate results. The computation unit further comprises first registers (e.g. areg1-3) and second registers (e.g. breg1-2) for temporarily storing first and second complex input values (i.e. A and B) retrieved from, for example, the internal buffer. A third register (e.g. wreg) may be provided to temporarily store the twiddle values.

The computation unit further comprises at least one multiplier and a plurality of adders to perform butterfly operations. Intermediate registers (e.g. creg, creg1-2, preg1-2, mreg and dreg) may be provided to store the intermediate results during the butterfly operations. The internal buffer and registers may comprise wordlengths wider than the wordlengths of input values (i.e. A and B) from the input buffers to reduce rounding errors. For example, a wordlengths of 18 or 36 bits may be provided for the intermediate results if the input values are 16-bits wide.

In one embodiment, the intermediate results are monitored for saturation and rounded-off if necessary by sat_rnd units 420 and 422. Saturation detection is performed on, for example, the most significant bits (e.g. bits 32 through bits 36.) If saturation is detected, the results are preferably limited to prevent wrap-around. For example, if the sign-bit is positive (i.e. zero), the result may be assigned the maximum positive number. If the sign-bit is negative (i.e. one), the result may be assigned the maximum negative value. The modified input values (Yᵣ and Yᵢ) are temporarily stored in registers yreg1 and yreg2 before writing to the internal buffer.

In one embodiment, the sat_detect unit 424 performs saturation detection on, for example, the last 2 most significant bits of the modified input values (Xᵣ and Xᵢ) stored in registers xreg1 and xreg2 before writing to the internal buffer. If saturation is detected, all the values retrieved from memory at the next stage may be scaled down and rounded by unit 426, which right-shifts the values. If no saturation is detected, no rounding is performed by unit 426.

In one embodiment, the total number of rounding (i.e. shifting) operations in the FFT or IFFT computations may be preset to, for example, four. The preset value is stored in, for example, configuration registers. If the number of shifts performed by the processor before the final stage is less than the preset number, the remaining number of rounding operations may be performed by rshift unit 428 in the final stage. Bit reversal may be performed by unit 430 before writing the final modified input values to the output buffers 404.

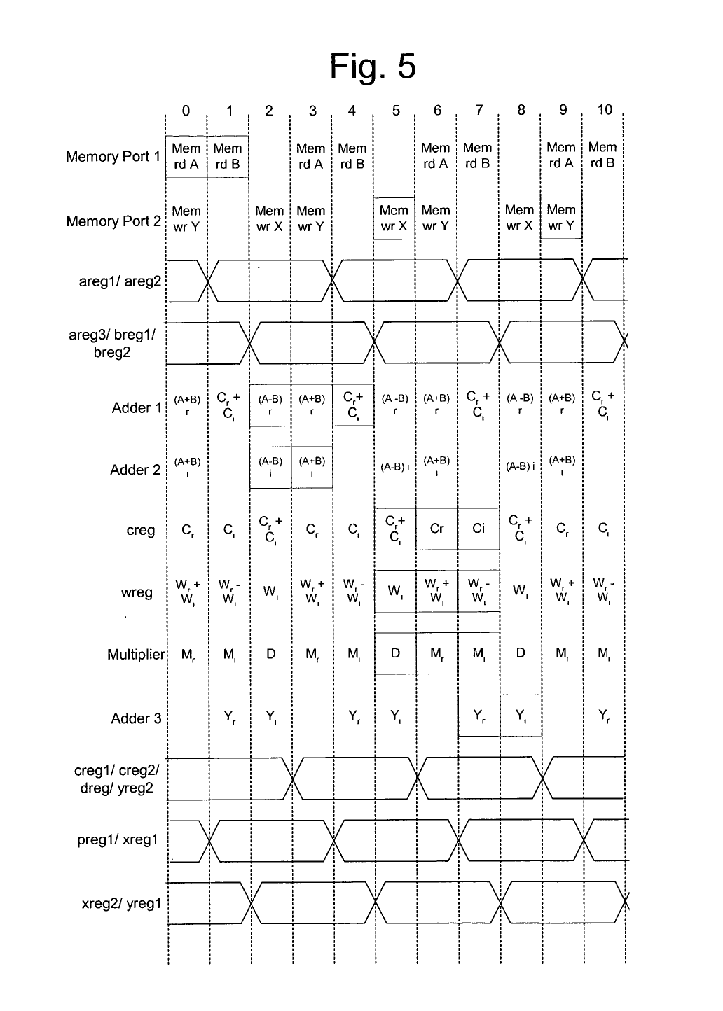

FIG. 5 shows the timing diagram of a pipelined butterfly operation of the FFT processor, according to one embodiment of the invention. A similar pipelined design may be used for the IFFT computation. Other types of pipeline designs are also useful. In one embodiment of the invention, the complex multiplication for the FFT butterfly may be completed in only three cycles using a single multiplier.

The input values from the input buffers may be transferred to the internal buffer during initialization. Referring to FIG. 5, the complex input data A is loaded via a Memory Port 1 from, for example, the internal buffer into the first registers (e.g. areg1 and areg2) during cycle 0. During cycle 1, the complex input data B is loaded via a Memory Port 2 into the second registers (e.g. breg1 and breg2). A single memory port for both data inputs A and B is also useful. In one embodiment, the data in areg1 is transferred to, for example, areg3 to free areg1 for new input data to be read from memory in cycle 3.

During cycle 2, the second registers are subtracted from the first registers, generating first and second differences (Cᵣ and Cᵢ). In one embodiment, Adder 1 produces the difference of the real parts of A and B (Cᵣ=Aᵣ−Bᵣ). Adder 2 produces the difference of the imaginary parts (Cᵢ=Aᵢ−Bᵢ). During cycle 3, the first registers (areg3 and areg2) are added to the second registers (breg1 and breg2) to generate X. For example, Adder 1 produces the sum of the real parts (Xᵣ=Aᵣ+Bᵣ) and the Adder 2 produces the sum of the imaginary parts (Xᵢ=Aᵢ+Bᵢ). The real and imaginary parts of X are loaded into the xreg1 and xreg2 registers. After saturation detection and rounding off, the X results are loaded into, for example, the internal buffer in cycle 5.

During cycle 4, the first and second differences (Cᵣ and Cᵢ) are added, generating a sum of the first and second differences. In one embodiment, Adder 1 forms the sum (Cᵣ+Cᵢ). In one embodiment of the invention, the multiplier is fully utilized, performing a multiplication in every cycle. Three multiply operations are performed to generate first, second and third partial products D, Mᵣ (partial Yᵣ) and Mᵢ (partial Yᵢ), where:

D=(Cᵣ+Cᵢ)*Wᵢ;

Mᵣ=Cᵣ(Wᵣ+Wᵢ); and

Mᵢ=Cᵢ(Wᵣ−Wᵢ)

The imaginary part of a twiddle factor W is loaded from memory (e.g. ROM) to a third register wreg. The multiplier performs a multiply operation between wreg and the sum (Cᵣ+Cᵢ) stored in creg, generating the first partial product D and storing it in, for example, register dreg.

In one embodiment, the twiddle sum (Wᵣ+Wᵢ) and twiddle difference (Wᵣ−Wᵢ) of the real and imaginary parts of the twiddle factor are pre-computed and stored in the memory to speed up the computation. The twiddle sum is loaded into the register wreg during cycle 6. The multiplier performs a multiply operation between wreg and the first difference Cᵣ stored in creg, generating the second partial product Mᵣ. During cycle 7, Adder 3 computes the modified second real input value (Yᵣ) by subtracting said first partial product D from said second partial product Mᵣ (i.e. Yᵣ=Mᵣ−D).

During the same cycle 7, the twiddle factor difference (Wᵣ−Wᵢ) is fetched from memory and loaded into wreg. The multiplier then forms the third partial product Mᵢ by performing a multiply operation between wreg and the second difference Cᵢ stored in creg. During the next cycle 8, the imaginary part of Y may be formed by adding the first partial product D and the third partial product Mᵢ (i.e. Yᵢ=Mᵢ+D), using Adder 3. Finally, the real and imaginary parts of Y are tested for saturation, rounded off if necessary and written to the internal memory at cycle 9.

While the invention has particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

What is claimed is:

1. A processor for performing fast Fourier-type transform operations, the processor comprising:
a memory unit for storing first and second real and imaginary input values, and modified first and second real and imaginary input values;
a computation unit coupled to the memory unit, said computation unit comprising a datapath unit, said datapath unit comprising at least one multiplier and a plurality of adders for performing butterfly operations on said first and second input values to generate modified first and second input values, said butterfly operation comprising three multiply operations and a plurality of add operations; and
intermediate registers in said computation unit for storing intermediate results, said intermediate results having wordlengths wider than wordlengths of said first and second input values for reducing rounding error.

2. The processor of claim 1 wherein the computation unit comprises a saturation detection and rounding unit.

3. The processor of claim 2 wherein said saturation detection and rounding unit limits the intermediate results when saturation is detected.

4. The processor of claim 2 wherein said saturation detection and rounding unit rounds off the intermediate results when saturation is detected.

5. The processor of claim 4 wherein the number of rounding operations is preset.

6. The processor of claim 1 wherein the computation unit comprises an internal buffer for storing intermediate results.

7. The processor of claim 1 wherein the memory unit comprises input buffers and output buffers.

8. A processor for performing fast Fourier-type transform operations, the processor comprising:
first registers for storing first real and imaginary input values;
second registers for storing second real and imaginary input values;
a datapath unit, said datapath unit performs butterfly operations on said first registers and said second registers a prescribed number of times, generating modified first real and imaginary input values and modified second real and imaginary input values, said butterfly operation comprising three multiply operations and a plurality of add operations, said datapath unit comprising at least one multiplier and a plurality of adders; and
intermediate registers for storing intermediate results, said intermediate results having wordlengths wider than wordlengths of said first and second input values for reducing rounding error.
